(19) United States
(12) Patent Application Publication
(10) Pub. No.: US 2026/0181664 A1
(43) Pub. Date: Jun. 25, 2026

(54) TRAINING METHOD FOR MACHINE LEARNING MODEL, TERMINAL DEVICE, AND NETWORK DEVICE

(71) Applicant: Quectel Wireless Solutions Co., Ltd., Shanghai (CN)

(72) Inventor: Zheng ZHAO, Shanghai (CN)

(73) Assignee: Quectel Wireless Solutions Co., Ltd., Shanghai (CN)

(21) Appl. No.: 19/540,512

(22) Filed: Feb. 13, 2026

Related U.S. Application Data
(63) Continuation of application No. PCT/CN2023/121051, filed on Sep. 25, 2023.

(51) Int. Cl. H04W 72/23; H04W 72/0446

(52) U.S. Cl. CPC H04W 72/23; H04W 72/0446

(57) ABSTRACT

A training method for a machine learning model includes: receiving, by a first terminal device, a first global model sent by a network device; and dividing, by the first terminal device, local data samples into a first data sample and a second data sample. The first data sample is used by the first terminal device to perform a first training on the first global model during a first training period, and the second data sample is used by the network device to perform a second training on the first global model during the first training period.

### CROSS-REFERENCE TO RELATED APPLICATIONS

This application is a continuation of International Application No. PCT/CN2023/121051, filed on Sep. 25, 2023, the disclosure of which is hereby incorporated by reference in its entirety.

### TECHNICAL FIELD

The present application relates to the technical field of communication, and more specifically, to a method and device for machine learning, and in particular to a training method for a machine learning model, a terminal device, and a network device.

### BACKGROUND

With the development of communication technologies, the implementation of intelligent services requires the support of high-performance machine learning models. A machine learning model can be trained in a distributed manner via a federated learning system, to obtain a high-performance machine learning model under the premise of protecting user privacy.

However, the federated learning system fails to fully make full use of the computing capability of network devices such as base stations to further improve the performance of the machine learning model. Moreover, model uploading and aggregation can result in significant latency overhead. Therefore, how to efficiently train the machine learning model is an urgent issue to be addressed.

### SUMMARY

A training method for a machine learning model, a terminal device, and a network device are provided according to the embodiments of the present disclosure. Various aspects involved in the embodiments of the present disclosure are described below.

In a first aspect, a training method for a machine learning model is provided that includes: receiving, by a first terminal device, a first global model sent by a network device; and dividing, by the first terminal device, local data samples into a first data sample and a second data sample. The first data sample is used by the first terminal device to perform a first training on the first global model during a first training period, and the second data sample is used by the network device to perform a second training on the first global model during the first training period.

In a second aspect, a training method for a machine learning model is provided that includes: sending, by a network device, a first global model to a plurality of terminal devices including a first terminal device; and receiving, by the network device, a plurality of second data samples sent by the plurality of terminal devices. The plurality of second data samples are determined according to local data samples of the plurality of terminal devices, and the local data samples are divided into first data samples and the second data samples, a plurality of first data samples of the plurality terminal devices are respectively used by the plurality of terminal devices to perform a first training on the first global model during a first training period, and the plurality of second data samples are used by the network device to perform a second training on the first global model during the first training period.

In a third aspect, a terminal device is provided. The terminal device is a first terminal device for training a machine learning model, and includes: a receiving unit receiving a first global model sent by a network device, and a processing unit dividing local data samples into a first data sample and a second data sample. The first data sample is used by the first terminal device to perform a first training on the first global model during a first training period, and the second data sample is used by the network device to perform a second training on the first global model during the first training period.

In a fourth aspect, a network device for training a machine learning model is provided that includes: a sending unit sending a first global model to a plurality of terminal devices including a first terminal device, and a receiving unit receiving, for the network device, a plurality of second data samples sent by the plurality of terminal devices. The plurality of second data samples are determined according to local data samples of the plurality of terminal devices, and the local data samples are divided into first data samples and the second data samples. A plurality of first data samples of the plurality terminal devices are respectively used by the plurality of terminal devices to perform a first training on the first global model during a first training period, and the plurality of second data samples are used by the network device to perform a second training on the first global model during the first training period.

In a fifth aspect, a communication device is provided that includes a memory and a processor, the memory is configured to store a program, and the processor is configured to call the program from the memory to execute the method according to any one of the first aspect and the second aspect.

In a sixth aspect, a device is provided that includes a processor configured to call a program from a memory, to execute the method according to any one of the first aspect and the second aspect.

In a seventh aspect, a chip is provided that includes a processor, configured to call a program from a memory, to cause a device installed with the chip to execute the method according to any one of the first aspect and the second aspect.

In an eighth aspect, a computer-readable storage medium is provided, and a program is stored on the computer-readable storage medium, to cause a computer to execute the method according to any one of the first aspect and the second aspect.

In a ninth aspect, a computer program product is provided that includes a program causing a computer to execute the method according to any one of the first aspect and the second aspect.

In a tenth aspect, a computer program is provided that causes a computer to execute the method according to any one of the first aspect and the second aspect.

In the embodiments of the present disclosure, after receiving a first global model, a terminal device divides local data samples into a first data sample and a second data sample. The first data sample is used by the terminal device to perform first training on the first global model, and the second data sample is used by the network device to perform second training on the first global model. Thus, it can be seen that the training method in the embodiments of the present disclosure combines the training performed by the terminal device and the training performed by the network device, which makes full use of the powerful computing capability of the network device and the effect of protecting data privacy through the local training on the terminal device, thus improving training efficiency.

### BRIEF DESCRIPTION OF THE DRAWINGS

FIG. 1 is a schematic diagram of a wireless communication system applied to an embodiment of the present disclosure.

FIG. 2 is a schematic flowchart of a federated learning process applied to an embodiment of the present disclosure.

FIG. 3 is a schematic flowchart of a centralized learning process applied to an embodiment of the present disclosure.

FIG. 4 is a schematic flowchart of a training method for a machine learning model provided by an embodiment of the present disclosure.

FIG. 5 is a schematic diagram of a possible implementation of an execution timing of the method shown in FIG. 4.

FIG. 6 is a schematic diagram of another possible implementation of an execution timing of the method shown in FIG. 4.

FIG. 7 is a schematic flowchart of a federated learning method based on retransmission-enabled over-the-air computation provided by an embodiment of the present disclosure.

FIG. 8 is a schematic flowchart of a retransmission-enabled over-the-air computation mechanism.

FIG. 9 is a schematic diagram of a federated learning system based on the retransmission-enabled over-the-air computation provided by an embodiment of the present disclosure.

FIG. 10 is a schematic structural diagram of a terminal device provided by an embodiment of the present disclosure.

FIG. 11 is a schematic structural diagram of a control device for the terminal device shown in FIG. 10.

FIG. 12 is a schematic structural diagram of a network device provided by an embodiment of the present disclosure.

FIG. 13 is a schematic structural diagram of a control device for the network device shown in FIG. 12.

FIG. 14 is a schematic structural diagram of an electronic device provided by an embodiment of the present disclosure.

FIG. 15 is a schematic block diagram of a communication device provided by an embodiment of the present disclosure.

### DETAILED DESCRIPTION OF THE EMBODIMENTS

The technical solutions in the embodiments of the present disclosure will be described below in combination with the accompanying drawings in the embodiments of the present disclosure. Apparently, the described embodiments are part of the embodiments of the present disclosure, rather than all of them. For the embodiments in the present disclosure, all other embodiments obtained by those skilled in the art without creative efforts shall fall within the protection scope of the present disclosure.

The embodiments of the present disclosure may be applied to various communication systems. For example, the embodiments of the present disclosure may be applied to a global system of mobile communication (GSM) system, a code division multiple access (CDMA) system, a wideband code division multiple access (WCDMA) system, a general packet radio service (GPRS), a long term evolution (LTE) system, an advanced long-term evolution (LTE-A) system, a new radio (NR) system, an evolution systems of a NR system, a LTE-based access to unlicensed spectrum (LTE-U) system, an NR-based access to unlicensed spectrum (NR-U) system, a non-terrestrial network (NTN) system, a universal mobile telecommunication system (UMTS), wireless local area networks (WLAN), wireless fidelity (WiFi) and a 5th-generation (5G) system. The embodiments of the present disclosure may also be applied to other communication systems, such as future communication systems. The future communication system may be, for example, a 6th-generation (6G) mobile communication system, or a satellite communication system.

Conventional communication systems have a limited number of supported connections and are relatively easy to implement. However, with the development of communication technology, communication systems can support not only conventional cellular communication but also one or more other types of communication. For example, a communication system can support one or more of the following types of communication: device to device (D2D) communication, machine to machine (M2M) communication, machine type communication (MTC), enhanced MTC (eMTC), vehicle to vehicle (V2V) communication, and vehicle to everything (V2X) communication. The embodiments of the present disclosure may also be applied to communication systems that support the above-mentioned communication modes.

The communication systems in the embodiments of the present disclosure may be applied to the carrier aggregation (CA) scenario, the dual connectivity (DC) scenario, and the standalone (SA) networking scenario.

The communication systems in the embodiments of the present disclosure may be applied to unlicensed spectrum. The unlicensed spectrum may also be regarded as shared spectrum. Alternatively, the communication systems in the embodiments of the present disclosure may be applied to licensed spectrum. The licensed spectrum may also be regarded as a dedicated spectrum.

The embodiments of the present disclosure may be applied to an NTN system. As an example, the NTN system may include an NTN system based on 4G, an NTN system based on NR, an NTN system based on internet of things (IoT) and an NTN system based on narrow band internet of things (NB-IoT).

A communication system may include one or more terminal devices. The terminal device mentioned in the embodiments of the present disclosure may also be referred to as user equipment (UE), access terminal, user unit, user station, mobile station (MS), mobile Terminal (MT), remote station, remote terminal, mobile device, user terminal, terminal, wireless communication device, user agent or user device, etc.

In some embodiments, the terminal device may be a STATION (ST) in a WLAN. In some embodiments, the terminal device may be a cellular phone, a cordless phone, a session initiation protocol (SIP) phone, a wireless local loop (WLL) station, a personal digital assistant (PDA) device, a handheld device with wireless communication function, a computing device or other processing devices connected to wireless modems, a vehicle-mounted device, a wearable device, a terminal device in the next generation communication system (such as NR system), or a terminal device in the future evolved public land mobile network (PLMN).

In some embodiments, the terminal device may be a device that provides voice and/or data connectivity to a user. For example, the terminal device may be a handheld device with wireless connection function, a vehicle-mounted device, and the like. As some specific examples, the terminal device may be a mobile phone, a Pad, a notebook computer, a palmtop, a mobile internet device (MID), a wearable device, a virtual reality (VR) device, an augmented reality (AR) device, a wireless terminal in industrial control, a wireless terminal in self driving, a wireless terminal in remote medical surgery, a wireless terminal in smart grid, a wireless terminal in transportation safety, a wireless terminal in smart city, and a wireless terminal in smart home, etc.

In some embodiments, the terminal device may be deployed on land. For example, the terminal device may be deployed indoors or outdoors. In some embodiments, the terminal device may be deployed on the water surface, such as on a ship. In some embodiments, the terminal device may be deployed in the air, such as on an aircraft, a balloon, or a satellite.

In addition to the terminal device, the communication system may include one or more network devices. The network device in the embodiments of the present disclosure is a device for communicating with the terminal device, which be referred to as an access network device or a radio access network device. For example, the network device may be a base station. The network device in the embodiments of the present disclosure may refer to a radio access network (RAN) node (or device) that connects the terminal device to the wireless network. The base station may broadly cover various names as follows, or may be replaced with the following names, such as: NodeB, evolved NodeB (eNB), next generation NodeB (gNB), relay station, access point, transmitting and receiving Point (TRP), transmitting point (TP), master evolved NodeB (MeNB), secondary evolved NodeB (SeNB), multi-standard radio (MSR) node, home base station, network controller, access node, wireless node, access point (AP), transmission node, transceiver node, base band unit (BBU), remote radio unit (RRU), active antenna unit (AAU), remote radio head (RRH), central unit (CU), distributed unit (DU), positioning node, etc. The base station may be a macro base station, a micro base station, a relay node, a donor node, or the like, or a combination thereof. The base station may also refer to a communication module, a modem, or a chip installed in the aforementioned device or equipment. The base station may also be a mobile switching center, a device that undertakes the functions of a base station in D2D, V2X, M2M communications, a network-side device in a 6G network, a device that undertakes the functions of a base station in a future communication system, etc. The base station may support networks with the same or different access technologies. The embodiments of the present disclosure do not limit the specific technology and specific device form adopted by the network device.

The base station may be stationary or mobile. For example, a helicopter or a drone may be configured to operate as a mobile base station, and one or more cells may move according to the position of the mobile base station. In other examples, a helicopter or a drone may be configured as a device to communicate with another base station.

In some deployments, the network device according to the embodiments of the present disclosure may be CU or DU, or the network device may include both CU and DU. gNB may further include AAU.

By way of example and not limitation, in the embodiments of the present disclosure, the network device may have mobility characteristics. For example, the network device may be a mobile device. In some embodiments of the present disclosure, the network device may be a satellite or a balloon station. In some other embodiments of the present disclosure, the network device may also be a base station located on land, in water areas, or other places.

In the embodiments of the present disclosure, the network device may provide services for a cell. The terminal device communicates with the network device through the transmission resources (such as frequency resources, or spectrum resources) used by the cell. The cell may be a cell corresponding to the network device (such as a base station). The cell may belong to a macro base station or a base station corresponding to a small cell. Herein, the small cell may include metro cell, micro cell, pico cell, femto cell, etc. The small cells have the characteristics of small coverage area and low transmission power, and are suitable for providing high-rate data transmission services.

Exemplarily, FIG. 1 is a schematic diagram of an architecture of a communication system provided by an embodiment of the present disclosure. As shown in FIG. 1, the communication system 100 includes a network device 110, which may be a device for communicating with a terminal device 120 (or referred to as a communication terminal or a terminal). The network device 110 can provide communication coverage for a specific geographical area and can communicate with terminal devices located within the coverage area.

FIG. 1 exemplarily shows one network device and two terminal devices. In some embodiments of the present disclosure, the communication system 100 may include multiple network devices, and the coverage area of each network device may include another quantity of terminal devices, which is not limited by the embodiments of the present disclosure.

In the embodiments of the present disclosure, the communication system shown in FIG. 1 may include other network entities such as a mobility management entity (MME) and an access and mobility management function (AMF), which is not limited by the embodiments of the present disclosure.

It should be understood that, in the embodiments of the present disclosure, devices with communication functions in the network/system can be referred to as communication devices. Taking the communication system 100 shown in FIG. 1 as an example, the communication device includes the network device 110 and the terminal devices 120 which both have communication functions. The network device 110 and the terminal devices 120 may be the specific devices described above, which will not be described herein. The communication device may also include other devices in the communication system 100, such as a network controller, a mobility management entity, and other network entities, which is not limited by the embodiments of the present disclosure.

In order to facilitate a detailed elaboration of innovative aspects of technical solutions, some related technical knowledge involved in the embodiments of the present disclosure will be introduced first. The following related technologies, as optional solutions, can be combined with the technical solutions of the embodiments of the present disclosure in any way, and all of them fall within the protection scope of the embodiments of the present disclosure. The embodiments of the present disclosure include at least some of the following content.

With the development of communication technologies, intelligent services require higher and higher performance of the machine learning model. For example, in the future 6G edge network, the development of an edge intelligence service needs to be supported by a machine learning model with excellent performance. The edge intelligent service includes unmanned driving, intelligent traffic management, security monitoring and other related services, for example.

However, data samples are stored in different terminal devices in the edge network, and how to efficiently use distributed data samples to train the machine learning model is thus a challenge that urgently to be addressed. At present, the methods for training the machine learning model in the edge network mainly include federated learning and centralized learning.

### Federated Learning System

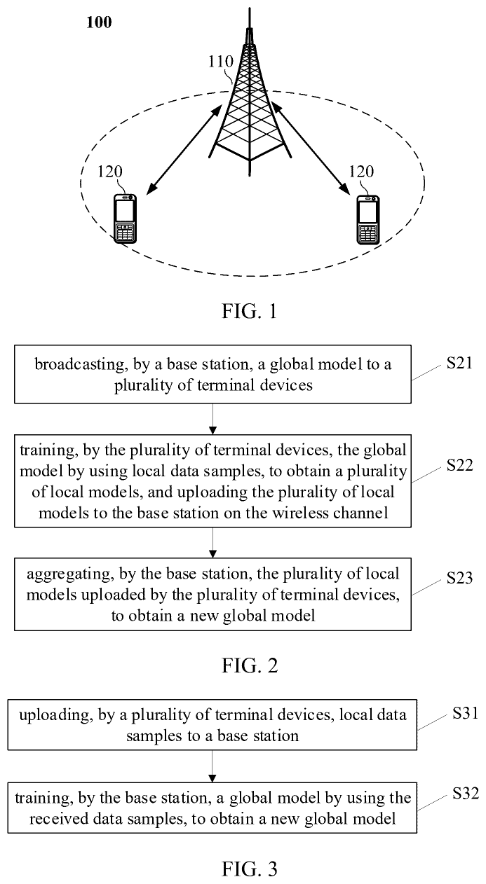

A federated learning system can realize the distributed training of a machine learning model for an edge intelligent service. Generally, the federated learning system in an edge network includes a base station and a plurality of terminal devices, and the federated learning process is divided into several rounds. Referring to FIG. 2, in a certain round, the federated learning process includes the following procedures:
S21: broadcasting, by a base station, a global model to a plurality of terminal devices. The global model is the machine learning model determined in the previous round.
S22: training, by the plurality of terminal devices, the global model by using local data samples, to obtain a plurality of local models, and uploading the plurality of local models to the base station on the wireless channel.
S23: aggregating, by the base station, the plurality of local models uploaded by the plurality of terminal devices, to obtain a new global model.

In the federated learning system, the base station and the plurality of terminal devices continuously repeat the above procedures from S21 to S23 until the global model meets preset convergence condition, at which point the federated learning is completed.

However, in the federated learning system, the powerful computing capability of the base station is not fully utilized for the training of the machine learning model. As mentioned above, the base station in the above-mentioned federated learning system is only responsible for aggregating the local models uploaded by the terminal devices and does not undertake the training task of the machine learning model, which wastes the powerful computing capability of the base station.

Furthermore, in the federated learning system, the uploading and aggregation processes of the local models are separated, resulting in low aggregation efficiency. In the above-mentioned federated learning system, the terminal devices generally upload local models following the method of digital communication. For example, the terminal device first encodes the local model into a bit stream and then uploads it to the base station using the wireless channel. Therefore, the base station needs to decode all the local models of the users and then aggregate all the local models to obtain the global model. The transmission method separates the uploading process from the aggregation process of the local models, causing a large latency overhead and reducing the aggregation efficiency.

### Centralized Learning System

A centralized learning system can realize centralized training of a machine learning model for an edge-intelligent service. The centralized learning system in the edge network includes a base station and a plurality of terminal devices. The centralized learning process is divided into several rounds. Referring to FIG. 3, in a certain round, the centralized learning process includes the following procedures:
S31: uploading, by a plurality of terminal devices, local data samples to a base station.
S32: training, by the base station, a global model by using the received data samples, to obtain a new global model. Herein, the global model to be trained is the machine-learning model determined in the previous round, and the new global model can be used in the next round.

In the centralized learning system, the base station and the plurality of terminal devices continuously repeat the above procedures S31 and S32 until the global model meets preset convergence conditions, at which point the centralized learning is completed.

However, in the centralized learning system, directly uploading the locally stored data samples by the terminal devices may expose data privacy. In the above-mentioned centralized learning system, the local data samples include privacy information related to the terminal devices. Directly uploading the local data samples to the base station will expose the privacy information of the terminal devices to the base station, thus bringing the risk of privacy leakage.

### Over-the-Air Computation

Over-the-air computation is a new type of non-orthogonal access method. Conventional orthogonal and non-orthogonal access methods only focus on how to transmit information from the sender to the receiver. However, over-the-air computation utilizes the superposition characteristics of wireless channels, so that multiple senders transmit information over the same time-frequency resource. In this way, the receiver receives the information from each sender after superposition or other processing methods. For example, the plurality of terminal devices respectively transmit a plurality of transmission blocks over the same time-frequency resource, and the base station, as the receiver, can receive the information of the terminal devices as the transmission blocks that are superimposed.

Furthermore, over-the-air computation requires certain pre-processing and post-processing at the sender and the receiver respectively. Through pre-processing and post-processing, over-the-air computation can implement various signal calculation methods during the communication process. It can be seen that over-the-air computation can unify the communication and computing processes.

The problems existing in federated learning and centralized learning for training the machine learning model respectively are described above. As can be seen from the above, federated learning can well protect the privacy of the user devices, but it fails to fully utilize the powerful computing capability of the base station. Moreover, the uploading and aggregation of the local models cause significant latency overhead, thus resulting in low training efficiency.

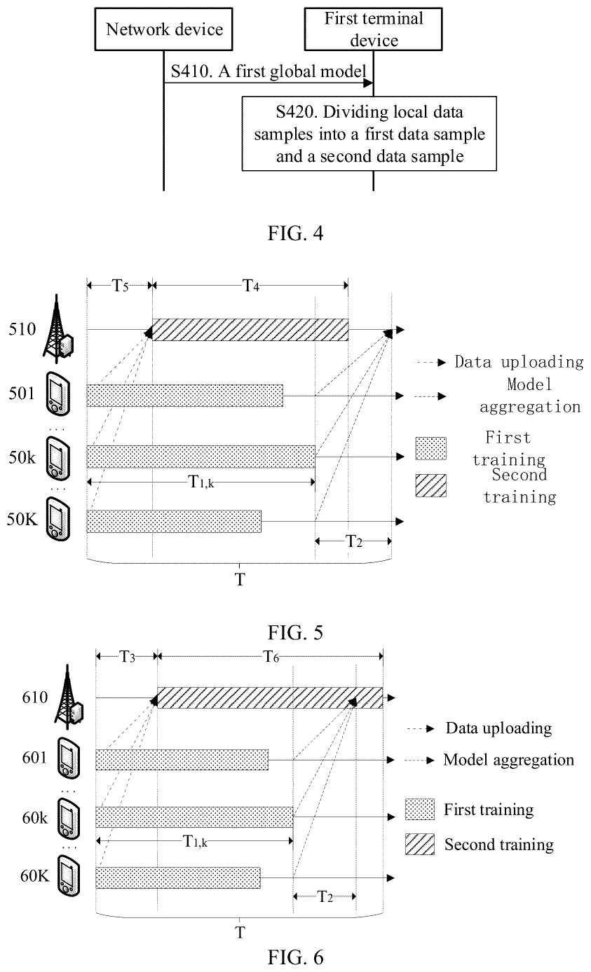

Based on this, a training method for a machine learning model is provided according to an embodiment of the present disclosure. Through the method, the powerful computing capability of the base station can be fully utilized to undertake the training tasks of the machine learning model, and the performance of the global model can also be improved. In order to facilitate understanding, the training method is described in detail with reference to FIG. 4.

FIG. 4 is introduced from the perspective of the interaction between a first terminal device and a network device. The first terminal device is a device with certain computing capability and communication capability among the terminal devices mentioned above. In some embodiments, the first terminal device may train the machine learning model based on the local data samples. In some embodiments, the first terminal device may send the data samples and the machine learning model to the network device. In some embodiments, the first terminal device may receive the machine learning model sent by the network device through broadcasting.

In some embodiments, the first terminal device may be any terminal device in the edge network. The first terminal device may store various data samples. The data samples stored by the first terminal device may include local data samples used for training a certain machine learning model.

In some embodiments, the first terminal device may be any terminal device in the edge network. The first terminal device may store various data samples. The data samples stored by the first terminal device may include local data samples for training a machine learning model.

The first terminal device is any one of a plurality of terminal devices participating in training the machine learning model. The plurality of terminal devices may jointly train the machine learning model with the network device. In some embodiments, the plurality of terminal devices may all provide data samples for the machine learning model.

The network device is any one of the communication devices mentioned above that provides services for the plurality of terminal devices. In some embodiments, the network device is a communication device with powerful computing capability. The network device may be the base station that broadcasts the global model to the plurality of terminal devices based on federated learning as mentioned above, or it may be the base station that trains the global model based on centralized learning as mentioned above, which is not limited herein.

The network device may communicate with the plurality of terminal devices including the first terminal device. In some embodiments, the network device may receive data samples or local models sent by the plurality of terminal devices. In some embodiments, the network device may send the global model of a certain round to the plurality of terminal devices.

Referring to FIG. 4, in a step S410, receiving, by the first terminal device, a first global model sent by the network device.

The first global model is a machine learning model that supports multiple intelligent services. In some embodiments, the first global model may be applied to the edge-intelligent services mentioned above.

The first global model may be various machine learning models, which are not limited in the embodiments of the present disclosure. The first global model includes but is not limited to: a convolutional neural network model, a recurrent neural network model, and generative adversarial networks, etc.

The first global model may be a machine learning model under training. The training method of a machine learning model generally includes multiple rounds. A round may refer to one round of the training process or the learning process, also known as a learning round or a training period. For example, in the federated learning mentioned above, one training period is used to complete the procedures from S21 to S23. Another example is that in the centralized learning mentioned above, one training period is used to complete the procedures of S31 and S32.

In some embodiments, during the process of training the machine learning model, the first global model may be the global model applied in any training period. That is, the first global model may be a model to be trained within any training period. In some embodiments, the first global model may be a model determined in the previous training period before any given training period. In other words, except for the training period when the model finally converges, the first global model may be a machine learning model determined in any other training period.

In some embodiments, the first global model may be determined by the network device. Exemplarily, the network device may integrate the information related to the first global model in the current training period, so as to determine the first global model for the next training period. For example, the network device may determine the first global model according to a training result of the current training period.

The training of the first global model is jointly executed by the network device and the plurality of terminal devices including the first terminal device. As mentioned above, the network device may broadcast the first global model to the plurality of terminal devices, so that all the terminal devices participating in the training of the machine learning model can receive the first global model determined in the previous training period.

In some embodiments, the process of the network device broadcasting the first global model to the plurality of terminal devices is included in the current training period. Exemplarily, the process may be used to determine a start moment of the current training period. For example, when the network device broadcasts the first global model, it indicates the start of the current training period. For another example, after the current training period starts, the network device broadcasts the first global model, and the first terminal device obtains the first global model by performing the step S410.

In some embodiments, the process of the network device broadcasting the first global model to the plurality of terminal devices is not included in the current training period. For example, the current training period starts after the first terminal device obtains the first global model by performing the step S410.

In a step S420, dividing, by the first terminal device, local data samples into a first data sample and a second data sample.

The local data samples may be various data samples used by the first terminal device to train the first global model. Exemplarily, the local data samples include but are not limited to pictures, audios, signals, etc., which are not limited in the embodiments of the present disclosure.

In some embodiments, a portion of the local data samples relate to the privacy information of the first terminal device. In some embodiments, a portion of the local data samples are the information disclosed by the first terminal device. In some embodiments, the local data samples include the information that the first terminal device does not want to be disclosed.

The first terminal device can obtain the local data samples in various ways. In some embodiments, the local data samples may be collected and determined by the first terminal device. In some embodiments, the local data samples may include the data samples stored locally by the first terminal device and the data samples collected by the first terminal device after receiving the first global model.

Dividing the local data samples into the first data sample and the second data sample may mean that the first terminal device divides the local data samples based on a certain division scheme to determine the first data sample and the second data sample.

The first data sample and the second data sample may be the data samples for training the first global model. In some embodiments, the local data samples may first be screened for data samples for training the model that are then divided. That is, the local data samples may include not only the first data sample and the second data sample for training, but also other data samples. In some embodiments, all the local data samples are divided to determine the first data sample and the second data sample. That is, the local data samples are comprised of the first data samples and the second data samples. In some embodiments, when the local data samples are divided, some data samples may be included in both the first data sample and the second data sample.

The data samples in the first data sample may be completely different from those in the second data sample, or be partially the same as those in the second data sample, which is not limited herein.

The local data samples are divided into the first data sample and the second data sample to train the first global model based on different training methods respectively, so as to effectively train the model. All of the plurality of terminal devices participating in training the the machine learning model may divide their local data samples into the first data sample and the second data sample.

The first data sample is used by the first terminal device to perform a first training on the first global model during a first training period, and the second data sample is used by the network device to perform a second training on the first global model during the first training period. That is, the first training is performed locally by the plurality of terminal devices, and the second training is performed by the network device. The training method utilizes the plurality of terminal devices and the network device for training, respectively, thus making full use of the powerful computing capability of the network device while protecting privacy as much as possible.

Each of the plurality of terminal devices participating in training the machine learning model performs the first training on the first global model based on the first data samples. The first training is used by the plurality of terminal devices including the first terminal device to obtain a plurality of local models.

In some embodiments, the first training is based on federated learning, and the second training is based on centralized learning. That is, the first training is a distributed training performed by the plurality of terminal devices including the first terminal device based on the federated learning system. The second training is a centralized training performed by the network device. In the present disclosure, the training method is semi-federated learning that combines federated learning and centralized learning. On the one hand, the terminal devices use a portion of the local data samples to train the global model to obtain the local models, and upload the local models to the network device for aggregation. The network device then obtains a federated learning aggregation model. On the other hand, the terminal devices upload another portion of the local data samples to the network device, and the network device uses its powerful computing capability to train the global model based on the another portion of the data to obtain a centralized learning model. Finally, the network device combines the federated learning aggregation model and the centralized learning model to obtain the global model. For simplicity, the semi-federated learning is used to describe the embodiments where the first training is based on federated learning and the second training is based on centralized learning.

In the above-mentioned embodiments, the first data samples are used for the first training, that is, the first data samples are used for federated learning. The first data samples may also be referred to as federated learning data samples. The second data samples are used for the second training, that is, the second data samples are used for centralized learning. The second data sample may also be referred to as centralized learning data samples. In this scenario, the local data samples are divided into the federated learning data samples and the centralized learning data samples.

There may be multiple ways to determine the division scheme for the local data samples. In some embodiments, the network device may determine a general division strategy, and the first terminal device may determine the final division scheme based on the division strategy and its own capability. For example, the division scheme for the local data samples may be first decided by the base station and then broadcasted by the same to all the terminal devices. For another example, the division scheme for the local data samples may be determined independently by each terminal device.

Exemplarily, the division scheme for the local data samples may be determined according to the type of data samples. As an example, the local data samples may be divided based on whether the local data samples involve privacy. For example, the data samples that involve the privacy of the first terminal device all belong to the first data samples that are not directly uploaded, so as to prevent the data samples sent to the network device from exposing the privacy information of the first terminal device. In the division scheme, the second data samples are related to the information disclosed by the first terminal device. Therefore, the information not disclosed by the first terminal device cannot be classified as the second data sample.

Exemplarily, the division scheme for the local data samples may be determined according to a sample number of the data samples. As an example, the sample number of the second data samples uploaded by the plurality of terminal devices to the network device may be equal. As another example, the plurality of terminal devices may divide the local data samples according to the same number proportion.

Exemplarily, the division scheme for the local data samples may be determined according to the capability of each terminal device. The capability of a terminal device may include a computing capability for training the first global model and a communication capability for uploading data samples and local models. As an example, the sample number of the first data samples and the sample number of the second data samples may be determined based on the communication capability and/or computing capability of the first terminal device. For example, when the computing capability of the first terminal device is relatively insufficient, the sample number of the second data samples may be greater than the sample number of the first data samples. For another example, the sample number of the second data samples may be positively correlated with the communication capability of the first terminal device.

The training methods for the first training and the second training may be relevant methods such as the gradient descent method, which are not limited herein. Exemplarily, the first terminal device may use the gradient descent method to train the first global model based on the first data sample to obtain a local model. The network device may use the gradient descent method to train the first global model based on the plurality of second data samples sent by the plurality of terminal devices to obtain a model.

In some embodiments, the first training and the second training are performed in parallel during the first training period to improve the efficiency of training the model. That is, during the first training period, the plurality of terminal devices and the network device may train the first global model in parallel. Taking federated learning and centralized learning as an example, during the training period, after receiving the first global model, the plurality of terminal devices may perform federated-learning-based distributed training on the first global model based on the first data samples. The plurality of terminal devices may also send the plurality of second data samples to the network device, so that the network device may perform centralized training on the first global model based on the plurality of second data samples during the training period.

As mentioned above, the training period refers to the duration required to complete one round of training when training a machine learning model. Taking the first global model as an example, completing one round of training may refer to the process of training the first global model to obtain a second global model after the first global model is determined. In the current training period, the second global model may be a new machine learning model determined based on the first global model. In the next training period, the second global model may serve as the first global model. By repeating the training over a plurality of training periods, the training (learning) process does not end until the global model converges. The first training period may be any one of the plurality of training periods.

Since the first training and the second training are performed in parallel, the duration of the first training period needs to comprehensively consider the durations of the two training methods to determine the duration of each learning round of the machine learning model. Exemplarily, a relevant period for the plurality of terminal devices to perform the first training may be referred to as a first sub-period, and a relevant period for the network device to perform the second training may be referred to as a second sub-period. Therefore, the first sub-period may also be referred to as a terminal device period, and the second sub-period may be referred to as a network device period.

In order to complete all the training, the first training period may be set as a maximum between the first sub-period and the second sub-period. Since the first sub-period and the second sub-period are parallel time periods, the duration of the first training period is the maximum of the duration of the first sub-period and the duration of the second sub-period.

In the first sub-period, the plurality of terminal devices perform the first training based on the first data samples and send the plurality of local models obtained from the training to the network device. Therefore, the first sub-period may be determined according to a plurality of first durations for the plurality of terminal devices to perform the first training and at least one second durations for sending the plurality of local models to the network device. Exemplarily, when there is a single second duration, the duration of the first sub-period is a sum of the maximum among the plurality of first durations and the second duration. Exemplarily, when there is a plurality of second durations, the plurality of first durations are respectively added to the plurality of second durations to obtain a plurality of sums. The duration of the first sub-period is a maximum among the plurality of sums

Exemplarily, the first duration refers to a duration for the terminal device to perform the first training, that is, duration for the terminal device to train the first global model. The durations for each of the terminal devices to perform the first training may not be the same. Therefore, the first training period may be a plurality of first durations with different lengths.

As an example, when the first terminal device uses the gradient-descent method to train the first global model, the first duration may be determined based on the number of times the first terminal device applies the gradient-descent method, the number of data samples used in each gradient-descent operation, the number of central processing unit (CPU) cycles required to process one data sample, and the CPU frequency of the first terminal device.

For example, among K terminal devices (where K is an integer greater than or equal to 1), the first duration for the k-th terminal device (where k is an integer ranging from 1 to K) may be represented as

$${T}_{t , k}^{FL} , and {T}_{t , k}^{FL}$$

may be determined as follows:

$${T}_{t , k}^{FL} = \frac{{\hat{I}}_{t} {\hat{D}}_{t} {\hat{C}}_{k}}{{\hat{f}}_{t , k}} ;$$

Where Îₜ is the number of times the k-th terminal device applies the gradient-descent method, \hat{D}ₜ is the number of data samples used by the k-th terminal device in each gradient-descent operation, Ĉₖ is the number of CPU cycles required for the k-th terminal device to process one data sample, and \hat{f}_{t,k} is the CPU frequency of the k-th terminal device.

Exemplarily, the second duration is duration for the terminal device to send the local model obtained from the first training to the network device. As an example, when each terminal device sends its local model separately, the second durations may not be the same, so there may be a plurality of second durations. As another example, when the plurality of terminal devices send the plurality of local models based on the over-the-air computation mechanism, they may send the plurality of local models over a same time-frequency resource, and the second durations corresponding to the plurality of terminal devices may be the same.

As an example, when parameters of the local model are divided into a plurality of transmission blocks for uploading, the second duration may be determined according to a total amount of parameters included in the local model, a total amount of parameters included in one model transmission block, the probability of successfully transmitting one model transmission block, and a time length occupied by one transmission block.

For example, the uploading period (second duration) of the local model may be denoted as

$${T}_{t}^{MA} , and {T}_{t}^{MA}$$

may be determined as follows:

$${T}_{t}^{MA} = \frac{⌈ {Q}^{M} / M ⌉}{{P}_{t}^{A}} {T}_{s} ;$$

Where Q^{M} is a total amount of parameters included in the local model, Mis a total amount of parameters included in one transmission block,

$${P}_{t}^{A}$$

is the probability of successfully transmitting one model transmission block, Tₛ is a time length occupied by one model transmission block, and ┌.┐ is the ceiling function.

In the second sub-period, the network device needs to first receive a plurality of second data samples from the plurality of terminal devices and then perform the second training based on the plurality of second data samples. Therefore, the second sub-period may be determined according to one or more third durations for the plurality of terminal devices to send the plurality of second data samples to the network device and a fourth duration for the network device to perform the second training. Exemplarily, when there is a single third duration, the duration of the second sub-period is a sum of the third duration and the fourth duration. Exemplarily, when there is a plurality of third durations, the plurality of third durations are respectively added to the fourth duration to obtain a plurality of sums. The duration of the second sub-period is a maximum among the plurality of sums.

Exemplarily, the third duration is duration for the plurality of terminal devices to send the second data samples to the network device. As an example, when each terminal device sends its second data samples separately, the third durations may not be the same, so there may be a plurality of third durations. As another example, when the plurality of terminal devices send the plurality of second data samples based on the over-the-air computation mechanism, they may send the plurality of second data samples over a same time-frequency resource, and the third durations corresponding to the plurality of terminal devices may be the same.

As an example, when parameters of the second data samples are divided into a plurality of data transmission blocks for uploading, the third duration may be determined according to a sample number of the second data samples, a total amount of parameters included in one data sample, a total amount of parameters included in one data transmission block, the probability of successfully transmitting one data transmission block, and a time length occupied by one transmission block.

For example, the uploading period (third duration) for the second data samples may be denoted as

$${T}_{t}^{DU} , and {T}_{t}^{DU}$$

may be determined as follows:

$${T}_{t}^{DU} = \frac{⌈ {\tilde{D}}_{t} {Q}^{D} / M ⌉}{{P}_{t}^{D}} {T}_{S} ;$$

Where \tilde{D}ₜ is a sample number of the second data samples uploaded by the terminal device, Q^{D} is a total amount of parameters included in one data sample, M is a total amount of parameters included in one transmission block,

$${P}_{t}^{D}$$

is the probability of successfully transmitting one data transmission block, Tₛ is a time length occupied by one data transmission block, and ┌.┐ is the ceiling function.

Exemplarily, the fourth duration is duration for the network device to perform the second training. Since the network device trains the first global model after receiving the plurality of second data samples, the first training period includes only a single fourth duration.

As an example, when the network device uses the gradient-descent method to train the first global model, the fourth duration may be determined based on the number of times the network device applies the gradient-descent method, the number of mixed data samples used in each gradient-descent operation, the number of CPU cycles required to process one mixed data sample, and the CPU frequency of the network device.

For example, the fourth duration of the network device may be denoted as

$${T}_{t}^{CL} ,$$

and the

$${T}_{t}^{CL}$$

may be determined as follows:

$${T}_{t}^{CL} = \frac{{\tilde{I}}_{t} {\overline{D}}_{t} \tilde{C}}{{\tilde{f}}_{t}} ;$$

Where Îₜ is the number of times the network device applies the gradient-descent method, \hat{D}ₜ is the number of mixed data samples used by the network device in each gradient-descent operation, \tilde{C} is the number of CPU cycles required for the network device to process one mixed data sample, and \tilde{f}ₜ is the CPU frequency of the network device.

In order to facilitate understanding, the federated learning is taken as an example for description. One learning round (training period) includes a terminal-device federated learning period, a local model uploading period, a centralized learning data sample uploading period, and a network-device centralized learning period. The lengths of the above-mentioned periods depend on the communication capability and computing capability of the terminal devices and the network device, and the division scheme of the data samples.

In the example, the terminal-device federated learning period and the local-model uploading period are in a serial relationship, and together form a terminal-device period. The centralized learning data sample uploading period and the network-device centralized learning period are in a serial relationship, and together form a network-device period. Further, the terminal-device period and the network-device period are in a parallel relationship.

In order to facilitate understanding, the training method based on over-the-air computation, hybrid federated learning, and centralized learning is taken as an example, and the timing relationship in the method shown in FIG. 4 is exemplarily described with reference to FIG. 5 and FIG. 6. The timings in FIG. 5 and FIG. 6 are used to indicate the timing relationship when the base station and the K terminal devices execute the method shown in FIG. 4. The communication devices in FIG. 5 include a base station 510, a terminal device 501, a terminal device 502, . . . , a terminal device 50k, . . . , and a terminal device 50K. The communication devices in FIG. 6 include a base station 610, a terminal device 601, a terminal device 602, . . . , a terminal device 60k, . . . , and a terminal device 60K.

In FIG. 5 and FIG. 6, T represents the duration of the first training period, T_{1,k} represents the first duration for the k-th terminal device to perform the first training based on federated learning, T₂ represents the second duration for uploading the local models and performing model aggregation based on over-the-air computation, T₃ represents the third duration for uploading the second data samples based on the over-the-air computation, and T₄ represents the fourth duration for the network device to perform the second training. For ease of explanation, among the K terminal devices, assume that the value of the first duration for the k-th terminal device is the largest, the duration of the first sub-period is the sum of T_{1,k} and T₂, and the duration of the second sub-period is the sum of T₃ and T₄.

Referring to FIG. 5, since the duration of the first sub-period is greater than the duration of the second sub-period, the first training period is the first sub-period. That is, the first training period T satisfies: T=max {T_{1,k}}+T₂.

Referring to FIG. 6, since the duration of the first sub-period is less than the duration of the second sub-period, the first training period is the second sub-period. That is, the first training period T satisfies: T=T₃+T₄.

As can be seen from FIG. 4 to FIG. 6, in the embodiments of the present disclosure, the terminal device divides the local data samples into the first data sample and the second data sample, which are respectively used by the terminal device and the network device to train the first global model in the current training period. The training method can make full use of the powerful computing capability of the network device. Under the circumstances that the second data samples do not involve the privacy information of the terminal device, the training method can also protect the privacy of the terminal device while improving the training efficiency.

As mentioned above, during the first training period, the purpose of training the first global model is to obtain the second global model. For example, a plurality of models obtained by training the first global model by the terminal devices and the network device respectively can be aggregated at the network device, and the network device determines the second global model.

In some embodiments, during the first training period, the plurality of terminal devices obtain the plurality of local models through the first training on the first global model, and the network device also obtains a model through the second training on the first global model. The plurality of local models and the model obtained from the second training are used by the network device to determine the second global model.

The second global model may be determined through various types of information, which may include one or more of the following: the first global model, the first aggregation model, the model obtained from the second training, a first weight corresponding to the first aggregation model, and a second weight corresponding to the model obtained from the second training.

Exemplarily, the first aggregation model may be determined based on the plurality of local models. For example, a portion or all of the local models among the plurality of local models may be used to determine the first aggregation mode with reference to federated learning. For another example, the plurality of local models may send the federated learning aggregation model to the network device based on the over-the-air computation mechanism.

Exemplarily, when the second training is based on centralized learning, the model obtained from the second training is a centralized learning model.

Exemplarily, the first weight corresponding to the first aggregation model is configured to determine the share of the first aggregation model in the second global model. The first weight is a non-negative real number less than or equal to 1. When the first training is based on federated learning, the first aggregation model is a federated learning aggregation model, and the first weight may also be referred to as a mixing weight for the federated learning aggregation model.

As an example, the first weight may be determined based on the first data samples after the plurality of terminal devices divide the local data samples and the mixed data samples for the second training. For example, the first weight may be determined according to a sample number of the first data samples obtained by dividing the local data samples of the plurality of terminal devices and a sample number of the mixed data samples.

As an example, the plurality of second data samples obtained by dividing the local data samples by the plurality of terminal devices are configured to determine the mixed data samples for the second training. When the plurality of terminal devices upload the plurality of second data samples to the network device based on the over-the-air computation mechanism, the network device receives a plurality of mixed data samples. However, the mixed data samples for the second training on the first global model may only include a portion of the second data samples, so as to improve the training efficiency while reducing the computational overhead.

For example, the network device may determine the mixed data samples for the second training from the plurality of second data samples based on a forgetting mechanism. That is, the mixed data samples may include a portion of the plurality of second data samples, and the portion of the second data samples is determined according to the forgetting mechanism.

Exemplarily, the second weight corresponding to the model obtained from the second training is configured to determine the share of the model in the second global model. The second weight is a non-negative real number less than or equal to 1. When the model obtained from the second training is a centralized learning model, the second weight may also be referred to as a mixing weight for the centralized learning model.

As an example, the second weight may be determined based on the first data samples obtained by dividing the local data samples by the plurality of terminal devices and the mixed data samples for the second training. For example, the second weight may be determined according to the sample number of the plurality of first data samples obtained by dividing the local data samples by the plurality of terminal devices and the sample number of the mixed data samples.

Exemplarily, a sum of the first weight and the second weight is 1, and both the first weight and the second weight are non-negative real numbers.

In some embodiments, the second global model may be jointly determined based on the first aggregation model, the first weight, the model obtained from the second training, and the second weight. For example, in a semi-federated learning system, the network device may mix the federated learning aggregation model and the centralized learning model according to the first weight and the second weight, respectively, so as to obtain the second global model.

In some embodiments, the second global model may be jointly determined based on the first global model, the first aggregation model, the first weight, the model obtained from the second training, and the second weight.

Exemplarily, the network device may add together the first global model, the product of the first aggregation model multiplied by the first weight, and the product of the model obtained from the second training multiplied by the second weight, so as to determine the second global model.

For example, when the second global model is represented by wₜ₊₁, wₜ₊₁ may be determined as:

$${w}_{t + 1} = {w}_{t} + {\hat{ρ}}_{t} Δ {\hat{w}}_{t} + {\tilde{ρ}}_{t} Δ {\overline{w}}_{t} .$$

Where wₜ represents the first global model, Δŵₜ represents the first aggregation model, Δ\tilde{w}ₜ represents the model obtained from the second training, \hat{ρ}ₜ represents the first weight, and \tilde{ρ}ₜ represents the second weight.

Optionally, in the semi-federated learning method, the first weight and the second weight may be respectively determined as:

$${\hat{ρ}}_{t} = \frac{{\sum }_{K = 1}^{K} {\hat{D}}_{t , k}}{{\sum }_{K = 1}^{K} {\hat{D}}_{t , k} + {\tilde{D}}_{t}^{BS}} ;$$

$${\tilde{ρ}}_{t} = \frac{{\tilde{D}}_{t}^{BS}}{{\sum }_{K = 1}^{K} {\hat{D}}_{t , k} + {\tilde{D}}_{t}^{BS}} ;$$

Where \hat{D}_{t,k} is the number of the data samples for the k-th federated learning, and

$${\tilde{D}}_{t}^{BS}$$

is the number of the mixed data samples for the base station.

After the network device determines the second global model, it can determine whether convergence is reached. That is, the second global model is used by the network device to determine whether the trained machine learning model reaches convergence. In some embodiments, the network device may use specific rules to determine whether the second global model reaches convergence.

In an embodiment, the convergence judgment rule for the second global model wₜ₊₁ may be determined as:

$$‖ {w}_{t + 1} - {w}_{t} ‖ \leq ε ;$$

Where ∥.∥ represents calculating the Euclidean norm (two-norm) of a vector, and ε represents the preset convergence accuracy.

In another embodiment, the convergence judgment rule for the second global model wₜ₊₁ may also be determined as:

$$\vert F ( {w}_{t + 1} ) - F ( {w}_{t} ) \vert \leq ε ;$$

Where F(w) represents a loss function calculated based on a certain global model w, which may be used to measure the training effect of the global model.

It should be understood that the above embodiments are merely for illustrating how to determine whether the global model converges or not. In addition to the convergence judgment rules mentioned above, any rule that can determine the objective convergence of the second global model may be applied to the embodiments of the present disclosure, which is not limited herein.

After determining that the global model satisfies the convergence condition, the network device may broadcast the final global model and the training termination instruction to the plurality of terminal devices. The plurality of terminal devices may stop collecting data samples and training local models.

In some embodiments, the network device and all of the terminal devices may release the time-frequency resources for uploading the local models and the second data samples.

In some embodiments, the network device may delete the received mixed data samples.

As can be seen from the above, by applying the semi-federated learning system based on retransmission-enabled over-the-air computation provided in the embodiments of the present disclosure, the powerful computing capability of the base station can be fully utilized to undertake the task of training a machine learning model, thereby improving the performance of the global model. At the same time, by uploading the local data samples and the local models based on a retransmission-enabled over-the-air computation mechanism provided in the embodiments of the present disclosure over the orthogonal time-frequency resources, the uploading and aggregation processes of the local models can be combined, so that the aggregation efficiency can be improved, and the privacy of the uploaded data samples can be protected simultaneously.

As mentioned above, over-the-air computation is mentioned with respect to the uploading of both the second data samples and the local models. Through a over-the-air computation mechanism, the uploading and aggregation processes of the local models can be combined, which improves the aggregation efficiency and protects the privacy of the uploaded data samples simultaneously. In order to perform the over-the-air computation, the plurality of terminal devices need to perform the uploading using the same resource.

In some embodiments, input signals for the over-the-air computation are signals sent by respective devices on which the over-the-air computation needs to be performed. The plurality of terminal devices may directly transmit signals based on the over-the-air computation mechanism, which is beneficial to improving the transmission efficiency. For example, when uploading local models, the communication device no longer needs to encode and decode the local models for many times, which can reduce the latency overhead.

Exemplarily, for the uploading process of the second data samples based on the over-the-air computation mechanism, the terminal devices may process second data sample segments into input signals for the over-the-air computation.

Exemplarily, for the uploading process of the local models based on the over-the-air computation mechanism, the terminal devices may process local model segments into input signals for the over-the-air computation.

In some embodiments, an output signal of the over-the-air computation is an over-the-air computed signal received by the network device.

Exemplarily, in semi-federated learning, for the uploading process of the second data samples based on the over-the-air computation mechanism, the output signal of the over-the-air computation is a mixed data sample segment.

Exemplarily, in semi-federated learning, for the uploading process of the local models based on the over-the-air computation mechanism, the output signal of the over-the-air computation is a federated learning aggregation model segment.

In some embodiments, the plurality of terminal devices may be scheduled to upload the second data samples using a same time-frequency resource, and the over-the-air computation technology may be used to realize the mixing of the local data samples during transmission. The model obtained by training the first global model using the mixed data samples directly received and used by the network device may be referred to as a centralized learning model. Since the network device only receives the mixed data samples instead of the uploaded original local data samples, the privacy of the uploaded data samples can be protected.

Exemplarily, the second data samples may be divided into a plurality of data transmission blocks based on the uploading period (the third duration). Each data transmission block carries a mixed data sample segment and occupies a fixed time length (for example, Tₛ). When a certain data transmission block is initially transmitted, the plurality of terminal devices participating in training the machine learning model simultaneously send the data transmission block to the base station over the same time-frequency resource.

In an embodiment, the second data sample may include one or more sample segments corresponding to one or more data transmission blocks. The one or more sample segments may include a first sample segment. The data transmission block corresponding to the first sample segment is a first data transmission block. Within the first training period, the plurality of terminal devices including the first terminal device may send a plurality of sample segments corresponding to the first data transmission block to the network device over a first resource. That is, the plurality of terminal devices send the plurality of sample segments simultaneously over the same resource.

As an example, one sample segment of each terminal device may correspond to one data transmission block. A plurality of sample segments of the plurality of terminal devices may be transmitted by one data transmission block. The first sample segment of the first terminal device is one of the plurality of sample segments.

As an example, the first resource may be the time-frequency resource for carrying the data transmission block, which is not limited herein.

As an example, the first sample segment and other sample segments are used as inputs to a first over-the-air computation. The first over-the-air computation may be configured to perform computation on a plurality of sample segments over the first resource.

In some embodiments, all terminal devices may be scheduled to upload the local models using the same time-frequency resource. The plurality of terminal devices may achieve the aggregation of the local models during the transmission based on the over-the-air computation technology. When the first training is federated learning, the network device may directly receive the federated learning aggregation model, thereby improving the aggregation efficiency.

Exemplarily, the local models may be divided into a plurality of model transmission blocks based on the uploading period (the second duration). Each model transmission block may carry a federated learning aggregation model segment and occupies a fixed time length (for example, Tₛ). When a certain model transmission block is initially transmitted, the plurality of terminal devices participating in training the machine learning model simultaneously send the model transmission block to the network device over the same time-frequency resource.

In an embodiment, the first local model may include one or more model segments corresponding to one or more model transmission blocks. The model segment may also be referred to as a model segment. The one or more model segments may include a first model segment. The model transmission block corresponding to the first model segment is a first model transmission block. Within the first training period, the plurality of terminal devices including the first terminal device may send a plurality of model segments corresponding to the first model transmission block to the network device over the second resource. That is, the plurality of terminal devices send the plurality of model segments simultaneously over the same resource.

As an example, one model segment of each terminal device may correspond to one model transmission block. A plurality of model segments of the plurality of terminal devices may be transmitted by one model transmission block. The first model segment of the first terminal device is one of the plurality of model segments.

As an example, the second resource may be the time-frequency resource for carrying the model transmission block. It should be understood that the second resource is orthogonal in time-frequency to the first resource. That is, the time-frequency resources used by the terminal devices during the local model uploading period are orthogonal to the time-frequency resources used by the terminal devices during the second data sample uploading period.

The methods for uploading the local models and the second data samples by the plurality of terminal devices based on the over-the-air computation mechanism are described above. However, the wireless channel changes rapidly, and it is difficult for a communication device to adjust a transceiver's configuration scheme in real time, resulting in transmission errors. For example, during the uploading process of the local model or the second data sample, the transmitter configuration of the terminal devices (including transmission power, transmit beamforming, etc.) and the receiver configuration of the network device (including receive beamforming, etc.) need to remain unchanged throughout the uploading period. However, the actual wireless channel state changes rapidly multiple times within the uploading period. It is difficult for the communication devices to adjust the transceiver's configuration in real time according to the wireless channel state, which causes transmission errors and affects the quality of the global model when the wireless channel state does not match the transceiver's configuration.

In order to solve the problem, a retransmission-enabled over-the-air computation mechanism is provided according to the embodiments of the present disclosure, which eliminates the real-time configuring of the transceivers during the uploading period by retransmitting the over-the-air computation results with relatively large errors, thus dealing with the rapidly changing wireless channel. For example, in the semi-federated learning method, the plurality of terminal devices requires the federated learning aggregation model segments and the mixed data sample segments. Through the retransmission-enabled over-the-air computation mechanism, for a federated learning aggregation model segment with an excessively large error, the network device can issue a retransmission command to all of the terminal devices, and the retransmission continues until the error of the segment is within a tolerable range. Correspondingly, for a mixed data sample segment with an excessively large error, the network device can issue a retransmission command to all of the terminal devices, and the retransmission continues until the error of the segment is within a tolerable range.

Exemplarily, the over-the-air-computation-based mechanism described above supports the first terminal device to retransmit the sample segments and/or the model segments that are failed to be transmitted.

Exemplarily, based on the retransmission-enabled over-the-air computation mechanism, the network device can receive the data transmission blocks or the model transmission blocks with small errors and initiate retransmission for the data transmission blocks or the model transmission blocks with large errors.

As an example, a third over-the-air computation may be any one of a plurality of over-the-air computations during the uploading of data samples and local models. For example, the third over-the-air computation may be the first over-the-air computation, a second over-the-air computation, or any other over-the-air computation.

Exemplarily, when the network device receives data transmission blocks sent by a plurality of terminal devices, it can evaluate the aggregation quality of the data transmission blocks. For a data transmission block that passes the aggregation quality evaluation, the network device receives it and extracts mixed data sample segments carried by the transmission block. For a data transmission block that fails to pass the aggregation quality evaluation, the network device discards the data transmission block and broadcasts a retransmission instruction to all of the terminal devices. After receiving the retransmission instruction, all of the terminal devices simultaneously resend the data transmission block to the network device over a same time-frequency resource until the network device passes the aggregation quality evaluation of the block.

Exemplarily, when the network device receives model transmission blocks sent by a plurality of terminal devices, it can evaluate the aggregation quality of the model transmission blocks. For a model transmission block that pass the aggregation quality evaluation, the network device receives it and extract the aggregation model segments carried by the transmission block. For a model transmission block that fails to pass the aggregation quality evaluation, the network device discards the model transmission block and broadcast a retransmission instruction to all of the terminal devices. After receiving the retransmission instruction, all of the terminal devices simultaneously resend the model transmission block to the network device over a same time-frequency resource until the network device passes the aggregation quality evaluation of the block.

Exemplarily, in the retransmission-enabled over-the-air computation mechanism, a plurality of terminal devices may be instructed to perform retransmission. Within the first training period, if an output signal of the third over-the-air computation does not satisfy a first condition, the first terminal device may receive a retransmission instruction sent by the network device. The retransmission instruction may be used to instruct the plurality of terminal devices to retransmit sample segments or model segments participating in the third over-the-air computation.

The first condition may be a preset standard for the quality of the output signal of over-the-air computation. That is, after receiving the output signal of over-the-air computation, the network device evaluates whether the quality of the output signal satisfies the preset standard.

In some embodiments, the quality of the output signal of over-the-air computation may be represented by the mean-square error (MSE) of the signal. The preset evaluation standard may be threshold-based evaluation standard.

Exemplarily, the first condition may be represented as:

$$M S E \leq ò$$

Where ò is a preset threshold, and MSE may be further determined as:

$$M S E = \frac{1}{K} ( {\sum }_{K = 1}^{K} {\vert {b}_{t}^{H} {h}_{t , k} - 1 \vert}^{2} + \frac{{\tilde{σ}}^{2}}{{ζ}_{t}} ) .$$

In the above formula,

$${b}_{t}^{H}$$

represents a normalized receive beamforming vector of the network device, satisfying ∥bₜ∥=1, ζₜ represents a normalization factor for the base station, satisfying ζₜ≥0, h_{t,k} represents a channel coefficient vector from a k-th terminal device to the network device, and \tilde{σ}² represents the receiver noise intensity of the network device.

It should be understood that the above embodiments only provide one evaluation standard for the output signal of over-the-air computation. Other evaluation standards that can objectively evaluate the quality of the output signal of over-the-air computation may also be applied to the embodiments of the present disclosure, which is not limited by the embodiments of the present disclosure.

The network device may send retransmission instructions to all of the terminal devices by broadcasting, or send retransmission instructions to the plurality of terminal devices participating in training the machine learning model by signaling.

The retransmission instructions sent by the network device to all the terminal devices may be indicated by one or more bits. In some embodiments, the retransmission instructions sent by the network device to all the terminal devices by broadcasting may be implemented using only one “1” bit signal. When the terminal device receives the “1” bit, the terminal device retransmits the input signals for the current over-the-air computation. When the terminal device receives a “0” bit, the terminal device continues to transmit the input signals for the subsequent over-the-air computation.

The methods for model transmission and data sample transmission based on the over-the-air computation mechanism and the retransmission-enabled over-the-air computation mechanism in the embodiments of the present disclosure are described above. In the semi-federated learning method, the training method provided by the embodiments of the present disclosure is a semi-federated learning system based on retransmission-enabled over-the-air computation.

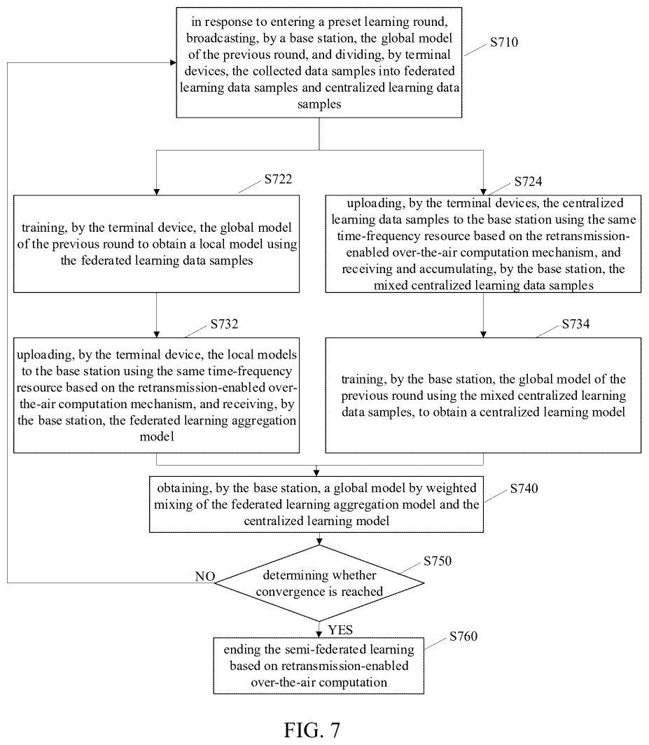

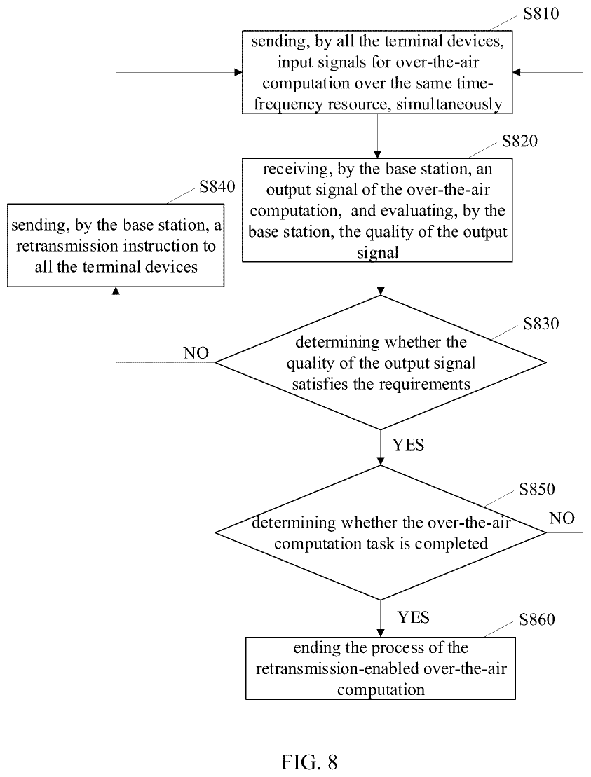

For ease of understanding, taking the network device being a base station as an example, the semi-federated learning based on retransmission-enabled over-the-air computation is described in combination with FIG. 7 and FIG. 8. FIG. 7 is a schematic flowchart of semi-federated learning based on retransmission-enabled over-the-air computation provided by an embodiment of the present disclosure. FIG. 8 is a schematic flowchart of a retransmission-enabled over-the-air computation mechanism provided by an embodiment of the present disclosure.

Referring to FIG. 7, in a step S710, in response to entering a preset learning round, a base station broadcasts the global model of the previous round, and terminal devices divide the collected data samples into federated learning data samples and centralized learning data samples.

In the step S710, the previous round refers to the previous training cycle, and the global model of the previous round is the first global model. The data samples collected by the terminal devices are local data samples. The federated learning data samples are the first data samples, and the centralized learning data samples are the second data samples.

Steps S722 and S732 refer to the first training and the local model uploading based on federated learning, and steps S724 and S734 refer to the second data sample uploading and the second training based on centralized learning. As shown in FIG. 7, steps S722 and S732 have a serial relationship, operations S724 and S734 have a serial relationship, steps S722 and S724 have a parallel relationship, and steps S732 and S734 have a parallel relationship.

In the step S722, the terminal devices perform training on the global model of the previous round to obtain a local model using the federated learning data samples. The training process occurs within the federated learning period of the terminal devices, that is, within the first duration mentioned above.

In the step S724, the terminal devices upload the centralized learning data samples to the base station using the same time-frequency resource based on the retransmission-enabled over-the-air computation mechanism, and the base station receives and accumulates the mixed centralized learning data samples. The uploading process of the centralized learning data samples occurs within the uploading period of the centralized learning data sample, that is, within the third duration mentioned above.

In the step S732, the terminal devices upload the local models to the base station using the same time-frequency resource based on the retransmission-enabled over-the-air computation mechanism, and the base station receives the federated learning aggregation model. The uploading process of the local models occurs within the uploading period of the local model, that is, within the second duration mentioned above.

In the step S734, the base station performs training on the global model of the previous round using the mixed centralized learning data samples, to obtain a centralized learning model. The training process occurs within the centralized learning period of the base-station, that is, within the fourth duration mentioned above.

In a step S740, the base station obtains a global model by weighted mixing of the federated learning aggregation model and the centralized learning model. The global model obtained by the base station is the second global model. After obtaining the federated learning aggregation model and the centralized learning model, the base station may multiply the federated learning aggregation model by a specific mixing weight (the first weight), and simultaneously multiply the centralized learning model by another specific mixing weight (the second weight), and then add these two results together.

In a step S750, the base station determines whether convergence is reached. If convergence is reached, a step S760 is performed. If convergence is not reached, the step S710 is performed.

In the step S760, the semi-federated learning based on retransmission-enable over-the-air computation is ended. The base station and the terminal devices may release the time-frequency resources for the uploading of the local models and the centralized data samples based on the retransmission-enabled over-the-air computation. Then, the base station may delete the received mixed data samples.

In the semi-federated learning system based on retransmission-enabled over-the-air computation shown in FIG. 7, the uploading process of the centralized learning data samples based on the retransmission-enabled over-the-air computation mechanism and the uploading process of the local models based on the retransmission-enabled over-the-air computation mechanism may use two sets of mutually orthogonal time-frequency resources.

Referring to FIG. 8, in a step S810, all the terminal devices simultaneously send input signals for the over-the-air computation over a same time-frequency resource. For the uploading process of the centralized learning data samples based on the retransmission-enabled over-the-air computation mechanism, the input signals for the over-the-air computation are the centralized learning data sample segments of the terminal devices. For the uploading process of the local models based on the retransmission-enabled over-the-air computation mechanism, the input signals for the over-the-air computation are the local model segments of the terminal devices.

In a step S820, the base station receives an output signal of the over-the-air computation and the base station evaluates the quality of the output signal. The output signal of the over-the-air computation is an over-the-air computed signal received by the base station. For the uploading process of the centralized learning data samples based on the retransmission-enabled over-the-air computation mechanism, the output signal of the over-the-air computation is the mixed data sample segments. For the uploading process of the local models based on the retransmission-enabled over-the-air computation mechanism, the output signal of the over-the-air computation is the federated learning aggregation model segments.

In a step S830, whether the quality of the output signal satisfies the requirements is determined. If the quality satisfies the requirements, a step S850 is performed. If the quality does not satisfy the requirements, a step S840 is performed.

In the step S840, the base station sends a retransmission instruction to all the terminal devices. After completing the quality evaluation of the output signal of the over-the-air computation, the base station discards the output signals that have not passed the evaluation and sends the retransmission instruction to all the terminal devices, and then the step S810 is continued.

In the step S850, whether the over-the-air computation task is completed is determined. The base station counts the number of the output signals of the over-the-air computation that have passed the evaluation. If the number is less than a preset total number of the output signals of the over-the-air computation task, the task is not completed. If the task is not completed, the step S810 is continued. If the task is completed, a step S860 is performed.

In the step S860, the process of the retransmission-enabled over-the-air computation is ended. If the base station's counted number of the output signals of the over-the-air computation that have passed the evaluation is equal to the preset total number of the output signals of the over-the-air computation task, the base station sends a retransmission-enabled over-the-air computation completion instruction to all the terminal devices. All the terminal devices stop sending input signals for the over-the-air computation, and the base station and the terminal devices release the time-frequency resources for retransmission-enabled over-the-air computation.

As can be seen from FIG. 8, when applying the retransmission-enabled over-the-air computation mechanism on a rapidly changing wireless channel, the base station does not need to optimize and change the transceiver configuration schemes of the terminal devices and the base station in real time according to the rapidly changing wireless channel state. On the contrary, the terminal devices and the base station maintain a fixed transceiver configuration scheme, and the base station only needs to determine whether the quality of the output signals of over-the-air computation satisfies a preset evaluation standard. The base station receives the output signals of the over-the-air computation that have passed the evaluation, discards the output signals of the over-the-air computation that have not passed the evaluation and initiates retransmission, and the retransmission continues until the signal satisfies the preset evaluation standard.

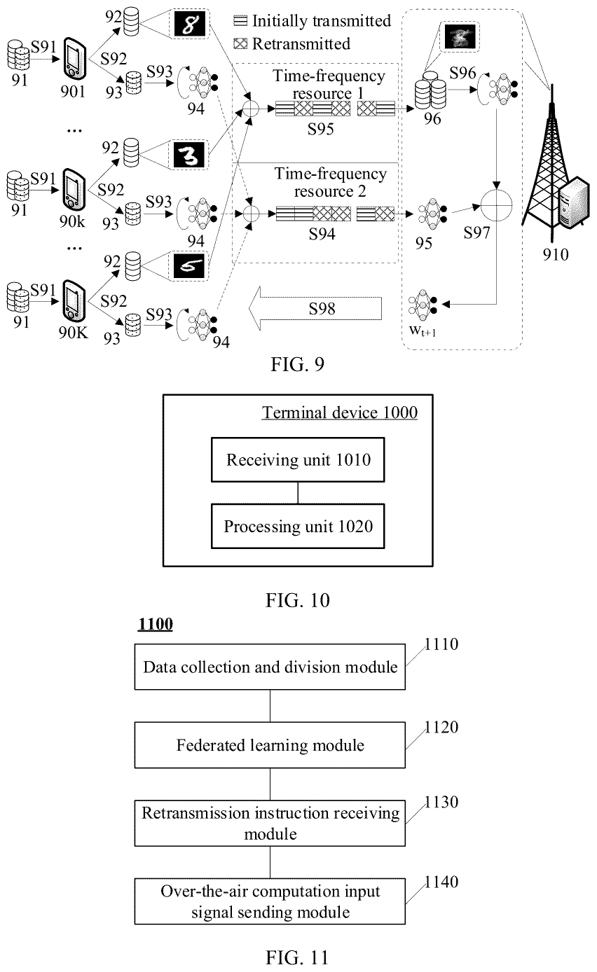

The embodiments of the present disclosure are described in more detail with a specific example of FIG. 9. It should be noted that the examples in FIG. 4 to FIG. 8 are merely intended to help those skilled in the art understand the embodiments of the present disclosure, rather than limiting the embodiments of the present disclosure to the specific numerical values or specific scenarios. Based on the examples in FIG. 4 to FIG. 8, those skilled in the art can obviously make various equivalent modifications or changes, and such modifications or changes also fall within the scope of the embodiments of the present disclosure.

FIG. 9 is a schematic diagram of a semi-federated learning system based on the retransmission-enabled over-the-air computation mechanism. As shown in FIG. 9, the semi-federated learning system based on the retransmission-enabled over-the-air computation mechanism includes one base station (Base Station 910) and K terminal devices. The K terminal devices are a terminal device 901, a terminal device 902, . . . , a terminal device 90k, . . . , and a terminal device 90K respectively.

The learning process shown in FIG. 9 is also divided into several training periods. When entering the current t-th learning round (the first training period), the K terminal devices receive a global model wₜ (the first global model) broadcast by the base station 910.

In a step S91, the K terminal devices collect local data samples 91. The local data samples 91 collected by the K terminal devices are D_{t,1}, D_{t,2}, . . . , D_{t,k}, . . . , D_{t,K}, respectively.

In a step S92, the K terminal devices divide the local data samples 91 into federated learning data samples 93 (first data samples) and centralized learning data samples 92 (second data samples) respectively. For example, the k-th terminal device divides D_{t,k} into a federal learning data sample \hat{D}_{t,k} and a centralized learning data sample \tilde{D}_{t,k}.

In a step S93, during the federated learning period of the terminal devices, the K terminal devices perform training on the global model wₜ broadcast by the base station using the federated learning data samples 93, to obtain local models 94. For example, the k-th terminal device trains the global model wₜ broadcast by the base station 910 using the federated learning data sample Dₜ,k to obtain the local model Δŵ_{t,k}. The local models obtained by the K terminal devices are Δŵ_{t,1}, Δŵ_{t,2}, . . . , and Δŵ_{t,K} respectively.

In a step S94, during a local model uploading period, the K terminal devices upload their local models 94 to the base station 910 over the same time-frequency resource (a time-frequency resource 2) based on the retransmission-enabled over-the-air computation mechanism, respectively. Then, the base station 910 receives the federated learning aggregation model segments with small errors and initiates retransmission of the federated learning aggregation model segments with large errors. Finally, the base station 910 obtains a federated learning aggregation model 95. The federated learning aggregation model 95 may be represented as Δwₜ. As can be seen from FIG. 9, the time-frequency resource 2 may be used to send local model aggregation based on retransmission-enabled over-the-air computation. The time-frequency resource 2 may carry the initially transmitted model segment and/or the retransmitted model segment.

In a step S95, during a centralized learning data sample uploading period, the K terminal devices upload their centralized learning data samples 92 to the base station 910 on the same time-frequency based on the retransmission-enabled over-the-air computation mechanism, respectively. The centralized learning data samples uploaded by the K terminal devices are \tilde{D}_{t,1}, \tilde{D}_{t,2}, . . . , and \tilde{D}_{t,K}, respectively. Then, the base station 910 receives the mixed data sample segments with small errors and initiates retransmission for the mixed data sample segments with large errors. As can be seen from FIG. 9, the time-frequency resource 1 may be used to send the mixed data samples based on retransmission-enabled over-the-air computation. The time-frequency resource 1 may carry the initially transmitted sample segment and/or the retransmitted sample segment.

In a step S96, during the centralized learning period of the base station 910, the base station 910 performs training on the global model wₜ using the mixed data samples 96, to obtain a centralized learning model Δwₜ. The mixed data samples 96 may be represented as \tilde{D}ₜ^{BS}.

In a step S97, at the end of the current t-th learning round, the base station 910 mixes the federated learning aggregation model Δŵₜ and the centralized learning model Δ\tilde{w}ₜ according to a weight \hat{ρ}ₜ and a weight \tilde{ρ}ₜ respectively, to obtain a global model wₜ₊₁ (the second global model) for the next learning round. As mentioned above, \hat{ρ}ₜ and \tilde{ρ}ₜ may be two non-negative real numbers satisfying \hat{ρ}ₜ+\tilde{ρ}ₜ=1.

In a step S98, the base station 910 broadcasts the global model wₜ₊₁ to all the terminal devices.

A learning system for a machine learning model is further provided according to the embodiments of the present disclosure. The learning system includes a network device and a plurality of terminal devices. Any terminal device among the plurality of terminal devices executes the operations for the terminal device to perform in the method described above, and the network device executes the operations for the network device to perform in the method described above.

The method embodiments of the present disclosure have been described in detail above in conjunction with FIG. 1 to FIG. 9. The device embodiments of the present disclosure will be described in detail in conjunction with FIG. 10 to FIG. 15. It should be understood that the description of the device embodiments corresponds to the description of the method embodiments. Therefore, for parts not described in detail, reference can be made to the previous method embodiments.

FIG. 10 is a schematic block diagram of a terminal device according to an embodiment of the present disclosure. The device 1000 may be a first terminal device for machine learning model training. The first terminal device may be any of the terminal devices described above. The terminal device 1000 shown in FIG. 10 includes a receiving unit 1010 and a processing unit 1020.

The receiving unit 1010 may be configured to receive a first global model sent by a network device.

The processing unit 1020 may be configured to divide local data samples into a first data sample and a second data sample. The first data sample is used by the first terminal device to perform a first training on the first global model during a first training period, and the second data sample is used by the network device to perform a second training on the first global model during the first training period.

Optionally, a sample number of the first data sample and a sample number of the second data sample are determined according to a communication capability and/or a computing capability of the first terminal device.

Optionally, the second data sample is related to information disclosed by the first terminal device.

Optionally, the second data sample includes a first sample segment, and the terminal device 1000 further includes a first sending unit configured to send, during the first training period, the first sample segment to the network device over a first resource based on an over-the-air computation mechanism. The first resource is further used by other terminal devices, excluding the first terminal device, to send additional sample segments to the network device, and the additional sample segments and the first sample segment are used as inputs to a first over-the-air computation.

Optionally, the first training is used by the first terminal device to determine a first local model, the first local model includes a first model segment, and the terminal device 1000 further includes a second sending unit configured to send, during the first training period, the first model segment to the network device over a second resource based on an over-the-air computation mechanism. The second resource is further used by other terminal devices, excluding the first terminal device, to send additional model segments to the network device, and the additional model segments and the first model segment are used as inputs to a second over-the-air computation.

Optionally, the over-the-air computation mechanism is configured to support retransmission, by the first terminal device, of a sample segment with a transmission failure and/or a model segment with a transmission failure.

Optionally, the receiving unit 1010 is further configured to receive, during the first training period and in response to an output signal of a third over-the-air computation failing to satisfy a first condition, a retransmission instruction sent by the network device. The retransmission instruction is used to instruct a plurality of terminal devices to retransmit sample segments or model segments participating in the third over-the-air computation.

Optionally, the first training is used by a plurality of terminal devices including the first terminal device to determine a plurality of local models, the plurality of local models and a model obtained from the second training are used by the network device to determine a second global model, and the second global model is used by the network device to determine whether the trained machine learning model reaches convergence.

Optionally, during the first training period, the plurality of local models are used to determine a first aggregation model, and the second global model is determined based on at least one of the following information: the first global model, the first aggregation model, the model obtained from the second training, a first weight corresponding to the first aggregation model, and a second weight corresponding to the model obtained from the second training.

Optionally, a sum of the first weight and the second weight is 1, and both the first weight and the second weight are non-negative real numbers.

Optionally, the first weight and the second weight are determined based on a sample number of a plurality of first data samples obtained by dividing the local data samples by the plurality of terminal devices and a sample number of mixed data samples for the second training.

Optionally, the mixed data samples are a portion of data samples among a plurality of second data samples obtained by dividing the local data samples by the terminal devices, and the portion of data samples are determined according to a forgetting mechanism.

Optionally, the first training and the second training are performed in parallel during the first training period.

Optionally, the first training period is a maximum of a first sub-period and a second sub-period, the first sub-period is related to the first training, and the second sub-period is related to the second training.

Optionally, the first training is used by a plurality of terminal devices including the first terminal device to determine a plurality of local models, and the first sub-period is determined according to a plurality of first durations for the plurality of terminal devices to perform the first training and at least one second duration for sending the plurality of local models to the network device.

Optionally, the first terminal device is any one of a plurality of terminal devices receiving the first global model, and the second sub-period is determined according to at least one third duration for the plurality of terminal devices to send a plurality of second data samples to the network device and a fourth duration for the network device to perform the second training.

Optionally, the first training is performed based on federated learning, and the second training is performed based on centralized learning.

FIG. 11 is a schematic structural diagram of a control device of the terminal device shown in FIG. 10. The control device 1100 may be configured to implement semi-federated learning based on retransmission-enabled over-the-air computation. As shown in FIG. 11, in the semi-federated learning system based on retransmission-enabled over-the-air computation, the control device 1100 of the terminal device may include a data collection and division module 1110, a federated learning module 1120, a retransmission instruction receiving module 1130, and an over-the-air computation input signal sending module 1140.

The data collection and division module 1110 may be configured to control the terminal device to collect local data samples and control the terminal device to divide the collected data samples into a federated learning data sample and a centralized learning data sample.

The federated learning module 1120 may be configured to control the terminal device to train the global model of a previous round by using the federated learning data sample to obtain a local model.

The retransmission instruction receiving module 1130 may be configured to control the terminal device to receive a retransmission instruction sent by a base station and control whether the terminal device retransmits a current over-the-air computation input signal according to the retransmission instruction.

The over-the-air computation input signal sending module 1140 may be configured to control the terminal device to process the over-the-air computation task into an over-the-air computation input signal and control the terminal device to send the over-the-air computation input signal over a same time-frequency resource.

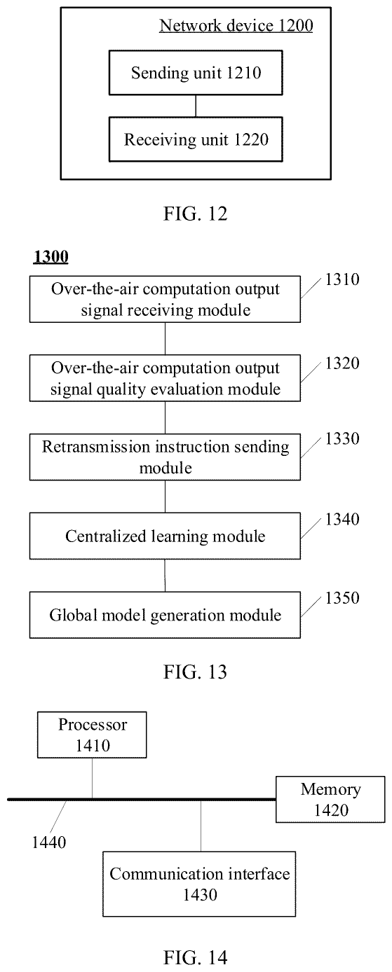

FIG. 12 is a schematic block diagram of a network device according to an embodiment of the present disclosure. The network device 1200 may be any of the network devices for machine learning model training as described above. The network device 1200 shown in FIG. 12 includes a sending unit 1210 and a receiving unit 1220.

The sending unit 1210 may be configured to send a first global model to a plurality of terminal devices including a first terminal device.

The receiving unit 1220 may be configured to receive, for the network device, a plurality of second data samples sent by the plurality of terminal devices. The plurality of second data samples are determined according to local data samples of the plurality of terminal devices, and the local data samples are divided into first data samples and second data samples. The plurality of first data samples of the plurality terminal devices are respectively used by the plurality of terminal devices to perform a first training on the first global model during a first training period, and the plurality of second data samples are used by the network device to perform a second training on the first global model during the first training period.

Optionally, the second data sample of the first terminal device includes a first sample segment, and the receiving unit 1220 is further configured to receive, during the first training period, an output signal of a first over-the-air computation based on an over-the-air computation mechanism. Input signals of the first over-the-air computation correspond to a plurality of sample segments sent by the plurality of terminal devices through a first resource, and the plurality of sample segments include the first sample segment.

Optionally, the first training is used by the first terminal device to determine a first local model, the first local model includes a first model segment, and the receiving unit 1220 is further configured to receive, during the first training period, an output signal of a second over-the-air computation based on an over-the-air computation mechanism. Input signals of the second over-the-air computation correspond to a plurality of model segments sent by the plurality of terminal devices over a second resource, and the plurality of model segments include the first model segment.

Optionally, the over-the-air computation mechanism supports retransmission, by the plurality of terminal devices, of a sample segment with a transmission failure and/or a model segment with a transmission failure.

Optionally, the sending unit 1210 is further configured to send, during the first training period and in response to an output signal of a third over-the-air computation failing to satisfy a first condition, a retransmission instruction to the plurality of terminal devices, and the retransmission instruction is used to instruct the plurality of terminal devices to retransmit sample segments or model segments participating in the third over-the-air computation.

Optionally, the first training is used by the plurality of terminal devices to determine a plurality of local models, the plurality of local models and a model obtained from the second training are used by the network device to determine a second global model, and the second global model is used by the network device to determine whether the trained machine learning model reaches convergence.

Optionally, during the first training period, the plurality of local models are used to determine a first aggregation model, and the second global model is determined based on at least one of the following information: the first global model, the first aggregation model, the model obtained from the second training, a first weight corresponding to the first aggregation model, and a second weight corresponding to the model obtained from the second training.

Optionally, a sum of the first weight and the second weight is 1, and both the first weight and the second weight are non-negative real numbers.

Optionally, the first weight and the second weight are determined based on a sample number of a plurality of first data samples obtained by dividing the local data samples by the plurality of terminal devices and a sample number of mixed data samples for the second training.

Optionally, the mixed data samples are a portion of data samples among a plurality of second data samples obtained by dividing the local data samples by the terminal devices, and the portion of data samples are determined according to a forgetting mechanism.

Optionally, the first training and the second training are performed in parallel during the first training period.

Optionally, the first training period is a maximum of a first sub-period and a second sub-period, the first sub-period is related to the first training, and the second sub-period is related to the second training.

Optionally, the first training is used by the plurality of terminal devices to determine a plurality of local models, and the first sub-period is determined according to a plurality of first durations for the plurality of terminal devices to perform the first training and at least one second duration for sending the plurality of local models to the network device.

Optionally, the second sub-period is determined according to at least one third duration for the plurality of terminal devices to send a plurality of second data samples to the network device and a fourth duration for the network device to perform the second training.

Optionally, the first training is performed based on federated learning, and the second training is performed based on centralized learning.

FIG. 13 is a schematic structural diagram of a control device of the network device shown in FIG. 12. The control device 1300 may be configured to implement semi-federated learning based on retransmission-enabled over-the-air computation. As shown in FIG. 13, in the semi-federated learning system based on retransmission-enabled over-the-air computation, the control device 1300 of the network device may include an over-the-air computation output signal receiving module 1310, an over-the-air computation output signal quality evaluation module 1320, a retransmission instruction sending module 1330, a centralized learning module 1340, and a global model generation module 1350.

The over-the-air computation output signal receiving module 1310 may be configured to control a base station to receive over-the-air computation output signals. For the uploading process of centralized learning data samples based on the retransmission-enabled over-the-air computation mechanism, the over-the-air computation output signals are mixed data sample segments. For the uploading process of local models based on the retransmission-enabled over-the-air computation mechanism, the over-the-air computation output signals are federated learning aggregation model segments.

The over-the-air computation output signal quality evaluation module 1320 may be configured to control the base station to evaluate whether the quality of the over-the-air computation output signals satisfies a preset standard.

The retransmission instruction sending module 1330 may be configured to control the base station to send a retransmission instruction to all the terminal devices according to a quality evaluation result of the over-the-air computation output signals.

The centralized learning module 1340 may be configured to control the base station to train the global model of a previous round by using the mixed centralized learning data samples, to obtain a centralized learning model.

The global model generation module 1350 may be configured to control the base station to obtain a global model by weighted mixing of a federated learning aggregation model and a centralized learning model.

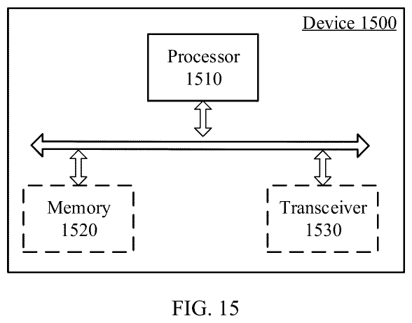

FIG. 14 is a schematic structural diagram of an electronic device provided by an embodiment of the present disclosure. The electronic device is used to implement any operation in the semi-federated learning process. As shown in FIG. 14, the structure of the electronic device includes a processor 1410, a memory 1420, a communication interface 1430, and a communication bus 1440.

The processor 1410 may be configured to execute a program stored in the memory 1420, and implement any operation in the semi-federated learning process based on retransmission-enabled over-the-air computation according to the embodiments of the present disclosure as described above.

The memory 1420 may be configured to store a program related to semi-federated learning based on retransmission-enabled over-the-air computation.

The communication interface 1430 may be configured for an external entity to modify a program stored in the memory 1420. The external entity includes but is not limited to maintenance personnel for semi-federated learning based on retransmission-enabled over-the-air computation, a system management device, etc., which is not limited by the embodiments of the present disclosure.

The communication bus 1440 may be configured to enable communication among the processor 1410, the memory 1420, and the communication interface 1430.

FIG. 15 is a schematic structural diagram of a communication device according to an embodiment of the present disclosure. The dotted lines in FIG. 15 indicate that the units or modules are optional. The device 1500 may be used to implement the method described in the above method embodiments. The device 1500 may be a chip, a terminal device, or a network device.

The device 1500 may include at least one processor 1510. The at least one processor 1510 may be configured to cause the device 1500 to implement the method described in the above method embodiments. The processor 1510 may be a general-purpose processor or a special-purpose processor. For example, the processor is a central processing unit (CPU). Alternatively, the processor may be other general-purpose processor, a digital signal processor (DSP), an application specific integrated circuits (ASIC), a field programmable gate array (FPGA) or other programmable logic device, a discrete gate or a transistor logic device, a discrete hardware component, etc. The general-purpose processor may be a microprocessor or the processor may be any conventional processor, etc.

The device 1500 may further include at least one memory 1520 storing a program thereon. The program may be executed by the processor 1510 to cause the processor 1510 to perform the method described in the above method embodiments. The memory 1520 may be separate from or integrated into the processor 1510.

The device 1500 may further include a transceiver 1530. The processor 1510 may communicate with other devices or chips via the transceiver 1530. For example, the processor 1510 may transmit and receive data with other devices or chips via the transceiver 1530.

A computer-readable storage medium configured to store a program is provided by an embodiment of the present disclosure. The computer-readable storage medium may be applicable to the terminal device or the network device provided by the embodiments of the present disclosure, and the program causes a computer to perform the method executed by the terminal device or the network device according to the embodiments of the present disclosure.

The computer-readable storage medium may be any available medium that a computer can read or a data storage device, such as a server or a data center that integrates at least one available medium. The available medium may be a magnetic medium, an optical medium or a semiconductor medium. Examples of computer storage media include but are not limited to: phase-change random access memory (PRAM), static random access memory (SRAM), dynamic random access memory (DRAM), other types of random access memory (RAM), read only memory (ROM), electrically erasable programmable read only memory (EEPROM), flash memory or other memory technologies, compact disc-read only memory (CD-ROM), solid state disk (SSD), digital video disc (DVD) or other optical storage, magnetic cassette tapes, tape/disk storage or other magnetic storage devices, or any other non-transmission medium. As defined herein, computer-readable medium does not include transitory computer-readable media such as modulated data signals and carrier waves.

Computer-readable medium includes permanent and non-permanent, removable and non-removable media, and may implement information storage by any method or technology. Computer-readable media may be used to store information that can be accessed by computing devices. The information may be computer-readable instructions, data structures, program modules, or other data.

A readable storage medium is further provided according to the embodiments of the present disclosure, on which a program or an instruction is stored. When the program or the instruction are executed by a processor, processes of the method embodiments shown in FIG. 1 to FIG. 9 may be implemented, and the same technical effects can be achieved. In order to avoid repetition, details are not described herein.

A computer program product configured to store a program is provided by an embodiment of the present disclosure. The computer program product includes a program. The computer program product may be applicable to the terminal device or the network device according to the embodiments of the present disclosure, and the program causes the computer to perform the method executed by the terminal device or the network device according to the embodiments of the present application.

The above embodiments may be implemented in whole or in part by software, hardware, firmware or any combination thereof. In case of being implemented in software, the embodiments may be fully or partially implemented in the form of a computer program product. The computer program product includes at least one computer instruction. When the at least one computer program instruction is loaded and executed on a computer, the flow or function described in the embodiments of the present disclosure is generated in whole or in part. The computer may be a general-purpose computer, a special-purpose computer, a computer network, or other programmable devices. The computer instruction may be stored in a computer-readable storage medium or transmitted from one computer-readable storage medium to another computer-readable storage medium. For example, the computer instruction may be transmitted from one website, computer, server or data center to another website, computer, server or data center by a wired way (such as a coaxial cable, an optical fiber, a digital subscriber line (DSL)), or a wireless way (such as infrared, wireless, microwave, etc.).

A computer program is further provided according to an embodiment of the present disclosure. The computer program may be applied to the terminal devices or the network devices according to the embodiments of the present disclosure, and the computer program causes a computer to execute the methods executed by the terminal devices or the network devices in various embodiments of the present disclosure.

The terms “system” and “network” in the embodiments of the present disclosure may be used interchangeably. In addition, the terms used in the present disclosure are only used to explain the specific embodiment of the present disclosure, and are not intended to limit the present disclosure. The terms “first”, “second”, “third”, and “fourth” are used to distinguish between different objects and are not intended to describe a particular order.

In addition, the terms “include” and “have”, and any variations thereof, are intended to cover non-exclusive inclusion. Thus, a process, method, article, or device that includes a series of elements not only includes those elements, but also includes other elements not explicitly listed, or also includes elements inherent to such a process, method, article, or device. Without further limitation, an element defined by the statement “include one . . . ” does not exclude the presence of another identical element in the process, method, article, or device that includes the element.

In the embodiments of the present disclosure, the term “indicate” may be a direct indication, an indirect indication, or an association relationship. For example, A indicates to B, which may mean that A indicates to B directly, for example, B may be obtained through A. Or it may mean that A indicates to B indirectly, for example, A indicates to C, and that B is obtained through C. Or, it may mean that A and B have an association relationship.

In the embodiments of the present disclosure, the term “correspond” may indicate a direct or indirect corresponding relationship between the two, or an associative relationship between the two, or a relationship between indicating and being indicated, or configuring and being configured, and the like.

In the embodiment of the present application, the “protocol” may refer to a standard protocol in the communication field, including, for example, LTE protocol, NR protocol and related protocols applied in future communication systems, which is not limited by the present disclosure.

In the embodiments of the present disclosure, determining B according to A does not mean determining B only according to A, but also according to A and/or other information.

In the embodiments of the present disclosure, the term “and/or” is only an association relationship describing the associated objects, which means that there may be three relationships. For example, A and/or B, which may mean that there are three situations: A, A and B, and B. In addition, the character “/” herein generally indicates an “or” relationship between the associated objects.

In the embodiments of the present disclosure, the magnitude of the reference numerals of the above processes does not imply the order of execution, and the order of execution of the processes should be determined by its function and inherent logic, without imposing any limitations on the implementation of the embodiments of the present disclosure.

In the embodiments of the present disclosure, it should be understood that the disclosed system, device and method can be realized in other ways. For example, the embodiments for the device described above are only schematic. For example, the division of the units is only a logical function division. In actual implementation, there may be other division methods, such as a plurality of units or components can be combined or integrated into another system, or some features can be ignored or not implemented. In addition, the coupling or direct coupling or communication connection shown or discussed can be indirect coupling or communication connection through some interfaces, devices or units, which can be electrical, mechanical or other forms.

The units described as separate components may or may not be physically separated, and the components displayed as units may or may not be physical units, that is, they may be located in one place or distributed to multiple network units. Some or all of the units can be selected according to actual needs to achieve the purpose of the embodiments of the present disclosure.

In addition, each respective functional unit in the embodiments of the present disclosure can be integrated into one processing unit, or each respective unit can exist physically, or two or more units can be integrated into one unit.

Through the description of the above embodiments, those skilled in the art can clearly understand that the above method embodiments can be implemented by means of software and a necessary general hardware platform or can also be implemented by hardware, but in many cases, the former is a better implementation. Based on such an understanding, the technical solution of the present disclosure, in essence, or the part that contributes to the prior art can be embodied in the form of a software product. The computer software product is stored in a storage medium (such as ROM/RAM, magnetic disk, optical disk), and includes several instructions for enabling a service classification device (which can be a mobile phone, a computer, a server, an air conditioner, or a network device, etc.) to execute the methods described in various embodiments of the present disclosure.

The above is only the specific embodiments of the present disclosure, but the protection scope of the present disclosure is not limited thereto. Any variations or substitutions that can be easily conceived by those skilled in the art within the technical scope disclosed by the present disclosure, should be included in the protection scope of the present disclosure. Therefore, the protection scope of the present disclosure should be based on the protection scope of the claims.

What is claimed is:

1. A training method for a machine learning model, comprising:
receiving, by a first terminal device, a first global model sent by a network device; and
dividing, by the first terminal device, local data samples into a first data sample and a second data sample;
wherein the first data sample is used by the first terminal device to perform a first training on the first global model during a first training period, and the second data sample is used by the network device to perform a second training on the first global model during the first training period.

2. The training method according to claim 1, wherein a sample number of the first data sample and a sample number of the second data sample are determined according to a communication capability and/or a computing capability of the first terminal device.

3. The training method according to claim 1, wherein the second data sample is related to information disclosed by the first terminal device.

4. The training method according to claim 1, wherein the second data sample comprises a first sample segment, and the training method further comprises:
during the first training period, sending, by the first terminal device, the first sample segment to the network device over a first resource based on an over-the-air computation mechanism;
wherein the first resource is further used by other terminal devices, excluding the first terminal device, to send additional sample segments to the network device, and the additional sample segments and the first sample segment are used as inputs to a first over-the-air computation.

5. The training method according to claim 1, wherein the first training is used by the first terminal device to determine a first local model, the first local model comprises a first model segment, and the training method further comprises:
during the first training period, sending, by the first terminal device, the first model segment to the network device over a second resource based on an over-the-air computation mechanism;
wherein the second resource is further used by other terminal devices, excluding the first terminal device, to send additional model segments to the network device, and the additional model segments and the first model segment are used as inputs to a second over-the-air computation.

6. The training method according to claim 4, wherein the over-the-air computation mechanism supports retransmission, by the first terminal device, of a sample segment with a transmission failure and/or a model segment with a transmission failure.

7. The training method according to claim 6, wherein the training method further comprises:
during the first training period, in response to an output signal of a third over-the-air computation failing to satisfy a first condition, receiving, by the first terminal device, a retransmission instruction sent by the network device, wherein the retransmission instruction is used to instruct a plurality of terminal devices to retransmit sample segments or model segments participating in the third over-the-air computation.

8. The training method according to claim 1, wherein the first training is used by a plurality of terminal devices comprising the first terminal device to determine a plurality of local models, the plurality of local models and a model obtained from the second training are used by the network device to determine a second global model, and the second global model is used by the network device to determine whether the trained machine learning model reaches convergence.

9. The training method according to claim 8, wherein during the first training period, the plurality of local models are used to determine a first aggregation model, and the second global model is determined based on at least one of the following information:
the first global model;
the first aggregation model;
the model obtained from the second training;
a first weight corresponding to the first aggregation model; and
a second weight corresponding to the model obtained from the second training.

10. The training method according to claim 9, wherein a sum of the first weight and the second weight is 1, and both the first weight and the second weight are non-negative real numbers.

11. The training method according to claim 9, wherein the first weight and the second weight are determined based on a sample number of a plurality of first data samples obtained by dividing the local data samples by the plurality of terminal devices and a sample number of mixed data samples for the second training.

12. The training method according to claim 11, wherein the mixed data samples are a portion of data samples among a plurality of second data samples obtained by dividing the local data samples by the terminal devices, and the portion of data samples are determined according to a forgetting mechanism.

13. The training method according to claim 1, wherein the first training and the second training are performed in parallel during the first training period.

14. The training method according to claim 1, wherein the first training period is a maximum of a first sub-period and a second sub-period, the first sub-period is related to the first training, and the second sub-period is related to the second training.

15. The training method according to claim 14, wherein the first training is used by a plurality of terminal devices comprising the first terminal device to determine a plurality of local models, and the first sub-period is determined according to a plurality of first durations for the plurality of terminal devices to perform the first training and at least one second duration for sending the plurality of local models to the network device.

16. The training method according to claim 14, wherein the first terminal device is any one of a plurality of terminal devices receiving the first global model, and the second sub-period is determined according to at least one third duration for the plurality of terminal devices to send a plurality of second data samples to the network device and a fourth duration for the network device to perform the second training.

17. The training method according to claim 1, wherein the first training is performed based on federated learning, and the second training is performed based on centralized learning.

18. A training method for a machine learning model, comprising:
sending, by a network device, a first global model to a plurality of terminal devices comprising a first terminal device; and
receiving, by the network device, a plurality of second data samples sent by the plurality of terminal devices, wherein the plurality of second data samples are determined according to local data samples of the plurality of terminal devices, and the local data samples are divided into first data samples and second data samples;
wherein a plurality of first data samples of the plurality terminal devices are respectively used by the plurality of terminal devices to perform a first training on the first global model during a first training period, and the plurality of second data samples are used by the network device to perform a second training on the first global model during the first training period.

19. The training method according to claim 18, wherein the second data sample of the first terminal device comprises a first sample segment, and receiving, by the network device, a plurality of second data samples sent by the plurality of terminal devices comprises:
during the first training period, receiving, by the network device, an output signal of a first over-the-air computation based on an over-the-air computation mechanism, wherein input signals of the first over-the-air computation correspond to a plurality of sample segments sent by the plurality of terminal devices through a first resource, and the plurality of sample segments comprise the first sample segment.

20. A terminal device, wherein the terminal device is a first terminal device for training a machine learning model, and the terminal device comprises:
a memory and a processor, wherein the memory is configured to store a program, and the processor is configured to invoke the program in the memory to perform:
receiving a first global model sent by a network device; and
dividing local data samples into a first data sample and a second data sample;
wherein the first data sample is used by the first terminal device to perform a first training on the first global model during a first training period, and the second data sample is used by the network device to perform a second training on the first global model during the first training period.
